(19) United States
(12) Patent Application Publication
(10) Pub. No.: US 2026/0220376 A1
(43) Pub. Date: Jul. 30, 2026

(54) Latent Hyperspace-Based Video Rendering from Physical Telemetry Streams

(71) Applicant: AtomBeam Technologies Inc., Moraga, CA (US)

(72) Inventor: Brian Galvin, Silverdale, WA (US)

(21) Appl. No.: 19/412,830

(22) Filed: Dec. 8, 2025

Related U.S. Application Data
(63) Continuation-in-part of application No. 19/401,343, filed on Nov. 25, 2025.
Application No. 19/401,343 is a continuation-in-part of application No. 19/390,468, filed on Nov. 14, 2025.
Application No. 19/390,468 is a continuation-in-part of application No. 19/380,869, filed on Nov. 5, 2025.
Application No. 19/380,869 is a continuation-in-part of application No. 19/369,319, filed on Oct. 26, 2025.
Application No. 19/369,319 is a continuation-in-part of application No. 19/363,675, filed on Oct. 21, 2025.
Application No. 19/363,675 is a continuation-in-part of application No. 19/351,286, filed on Oct. 6, 2025.
Application No. 19/351,286 is a continuation-in-part of application No. 19/321,173, filed on Sep. 6, 2025, now Pat. No. 12,602,549.
Application No. 19/321,173 is a continuation-in-part of application No. 19/284,115, filed on Jul. 29, 2025.
Application No. 19/284,115 is a continuation of application No. 19/051,193, filed on Feb. 12, 2025, now Pat. No. 12,387,050.
Application No. 19/369,319 is a continuation-in-part of application No. 19/328,179, filed on Sep. 14, 2025.
Application No. 19/328,179 is a continuation-in-part of application No. 19/326,730, filed on Sep. 12, 2025, now Pat. No. 12,608,555.
Application No. 19/326,730 is a continuation-in-part of application No. 19/321,173, filed on Sep. 6, 2025, now Pat. No. 12,602,549.
Application No. 19/321,173 is a continuation-in-part of application No. 19/245,366, filed on Jun. 22, 2025, now Pat. No. 12,418,680.
Application No. 19/245,366 is a continuation-in-part of application No. 19/204,525, filed on May 10, 2025.
Application No. 19/204,525 is a continuation-in-part of application No. 19/192,215, filed on Apr. 28, 2025.
Application No. 19/192,215 is a continuation-in-part of application No. 18/972,797, filed on Dec. 6, 2024, now Pat. No. 12,294,392.
Application No. 18/972,797 is a continuation-in-part of application No. 18/648,340, filed on Apr. 27, 2024, now Pat. No. 12,166,507.
Application No. 18/648,340 is a continuation-in-part of application No. 18/427,716, filed on Jan. 30, 2024, now Pat. No. 12,093,972.
Application No. 18/427,716 is a continuation-in-part of application No. 18/410,980, filed on Jan. 11, 2024, now Pat. No. 12,068,761.
Application No. 18/410,980 is a continuation-in-part of application No. 18/537,728, filed on Dec. 12, 2023, now Pat. No. 12,058,333.
Application No. 18/537,728 is a continuation-in-part of application No. 19/329,369, filed on Sep. 15, 2025.
Application No. 19/329,369 is a continuation-in-part of application No. 19/328,199, filed on Sep. 14, 2025, now Pat. No. 12,645,884.
Application No. 19/328,199 is a continuation-in-part of application No. 19/328,179, filed on Sep. 14, 2025.
Application No. 19/328,179 is a continuation-in-part of application No. 19/328,103, filed on Sep. 13, 2025, now Pat. No. 12,639,521.
Application No. 19/328,103 is a continuation-in-part of application No. 19/326,730, filed on Sep. 12, 2025, now Pat. No. 12,608,555.
Application No. 19/390,468 is a continuation-in-part of application No. 19/203,069, filed on Jun. 3, 2025, now Pat. No. 12,481,688.
Application No. 19/203,069 is a continuation-in-part of application No. 19/205,960, filed on May 12, 2025.
Application No. 19/205,960 is a continuation-in-part of application No. 19/060,794, filed on Feb. 24, 2025.
Application No. 19/060,794 is a continuation-in-part of application No. 19/044,546, filed on Feb. 3, 2025.
Application No. 19/044,546 is a continuation-in-part of application No. 19/026,276, filed on Jan. 16, 2025.
Application No. 19/026,276 is a continuation-in-part of application No. 18/928,022, filed on Oct. 26, 2024.
Application No. 18/928,022 is a continuation-in-part of application No. 18/919,417, filed on Oct. 17, 2024, now Pat. No. 12,602,586.
Application No. 18/919,417 is a continuation-in-part of application No. 18/918,077, filed on Oct. 17, 2024.
Application No. 18/918,077 is a continuation-in-part of application No. 18/737,906, filed on Jun. 7, 2024.
Application No. 18/737,906 is a continuation-in-part of application No. 18/736,498, filed on Jun. 6, 2024.
(60) Provisional application No. 63/651,359, filed on May 23, 2024.
(60) Provisional application No. 63/847,082, filed on Jul. 19, 2025.
(60) Provisional application No. 63/847,091, filed on Jul. 19, 2025.
(60) Provisional application No. 63/847,096, filed on Jul. 19, 2025.
(60) Provisional application No. 63/847,101, filed on Jul. 19, 2025.
(60) Provisional application No. 63/847,889, filed on Jul. 21, 2025.
(60) Provisional application No. 63/887,491, filed on Sep. 24, 2025.

(51) Int. Cl. G06F 40/30; G06F 16/332; G06F 16/3329

(52) U.S. Cl. CPC G06F 40/30; G06F 16/3325; G06F 16/3329

(57) ABSTRACT

A computer-implemented system generates predictive video representations of physical system behavior from non-visual telemetry data. Sensor inputs including vibration, acoustic, flow, pressure, thermal, chemical, and electromagnetic measurements are encoded into mathematical representations within a latent geometric manifold that preserves temporal and cross-modal relationships. The system forecasts future states by computing geometric trajectories through the manifold using geodesic forecasting, stochastic perturbations, and historical trajectory matching, and combines results through Bayesian fusion to form probabilistic predictions. These predictions are projected into visual coordinates and rendered as synthetic video sequences illustrating anticipated system evolution. Uncertainty is visually encoded using opacity gradients, branching trajectories, and probabilistic overlays to convey confidence levels. A manifold journaling framework maintains reversible correspondence between predictive video frames and originating telemetry data, enabling auditability, verification, and traceable reconstruction of predictions back to their sensor sources.

### CROSS-REFERENCE TO RELATED APPLICATIONS

Priority is claimed in the application data sheet to the following patents or patent applications, each of which is expressly incorporated herein by reference in its entirety:
Ser. No. 19/401,343
Ser. No. 19/390,468
Ser. No. 19/380,869
Ser. No. 19/369,319
Ser. No. 19/363,675
Ser. No. 19/351,286
Ser. No. 19/321,173
Ser. No. 19/284,115
Ser. No. 19/051,193
63/847,082
63/847,091
63/847,096
63/847,101
Ser. No. 19/328,179
Ser. No. 19/326,730
63/847,889
Ser. No. 19/245,366
Ser. No. 19/204,525
Ser. No. 19/192,215
Ser. No. 18/972,797
Ser. No. 18/648,340
Ser. No. 18/427,716
Ser. No. 18/410,980
Ser. No. 18/537,728
63/887,491
Ser. No. 19/329,369
Ser. No. 19/328,199
Ser. No. 19/328,103
Ser. No. 19/203,069
Ser. No. 19/205,960
Ser. No. 19/060,794
Ser. No. 19/044,546
Ser. No. 19/026,276
Ser. No. 18/928,022
Ser. No. 18/919,417
Ser. No. 18/918,077
Ser. No. 18/737,906
Ser. No. 18/736,498
63/651,359

### BACKGROUND OF THE INVENTION

### Field of the Art

The present invention relates to the field of machine-implemented data processing and visualization systems, and more specifically to systems and methods for generating predictive visual representations of physical system behavior from heterogeneous non-visual telemetry data using latent manifold encoding and geometric forecasting techniques.

### Discussion of the State of the Art

Modern industrial, scientific, and environmental systems generate vast quantities of telemetry data from diverse non-visual sensors. These sensor modalities-such as vibration, acoustic, flow, pressure, thermal, chemical, and electromagnetic detectors-provide high-frequency, multidimensional measurements that characterize the dynamic behavior of physical systems. Conventional monitoring and visualization approaches, however, typically reduce such complex data streams to scalar plots, dashboards, or numerical indicators that are difficult for human operators to interpret intuitively.

Efforts to convert non-visual telemetry into visual or graphical form have primarily focused on real-time condition monitoring or post hoc simulation. For example, physics-based simulation platforms may model fluid flow, structural stress, or thermal diffusion, but they require explicit equations and domain-specific model construction. Similarly, visualization dashboards can render simplified status graphics or parameter trends, yet they are limited to representing current or past conditions. These methods do not directly synthesize predictive visualizations from raw sensor data, nor do they provide reversible mappings between visual output and underlying telemetry.

Recent advances in machine learning and generative modeling have introduced data-driven techniques for video synthesis, yet such systems generally function as black-box models. They lack geometric interpretability, auditable traceability, and the ability to integrate heterogeneous sensor modalities within a physically consistent latent space. Moreover, conventional predictive analytics and anomaly detection algorithms operate on abstract feature sets and produce statistical forecasts rather than tangible, time-evolving visual representations of system behavior.

As a result, operators monitoring critical assets-such as power generation facilities, aircraft structures, or biomedical systems-lack tools that can both forecast system evolution and display those forecasts as visually intelligible, physically constrained video. They also lack mechanisms for quantifying and visualizing uncertainty in such forecasts, or for auditing how predicted outcomes derive from specific telemetry inputs.

What is needed is a machine-implemented system that transforms heterogeneous, non-visual telemetry streams into predictive, uncertainty-aware video representations of anticipated system behavior—anchored in a latent geometric manifold that maintains auditability, physical plausibility, and reversible correspondence to the source sensor data.

### SUMMARY OF THE INVENTION

The inventor has conceived and reduced to practice a computer-implemented system that generates predictive visual representations of physical system behavior from non-visual telemetry streams. The system maintains a persistent cognitive substrate that encodes heterogeneous sensor data—such as vibration, acoustic, flow, pressure, thermal, chemical, or electromagnetic telemetry—within a latent manifold representing geometric and temporal relationships among system states. Through the integration of geodesic forecasting, stochastic rollouts, and Bayesian fusion of historical data, the invention produces synthetic video sequences that visually depict the anticipated evolution of a monitored physical system. These predictive visualizations are auditable, reversible to their originating sensor data, and include explicit uncertainty encodings to convey confidence levels and potential risk conditions before they physically manifest.

In an embodiment, a computer system is implemented with a hardware memory configured to execute software instructions that maintain a cognitive substrate incorporating a latent manifold containing geometric representations of system states. The computer system receives telemetry data from multiple non-visual sensor modalities monitoring a physical system and encodes the telemetry data into tensor-preserving latent representations that retain both geometric structure and temporal correlation. The system computes predictive trajectories through the latent manifold using geodesic forecasting operators, stochastic perturbation kernels, or historical trajectory matching so as to model how the system is likely to evolve. Projection operators then transform these predictive trajectories into visual manifold coordinates under domain-specific physical constraints and uncertainty bounds. From these coordinates, the system generates synthetic video outputs that depict the predicted future states of the physical system, thereby providing visual forecasts derived directly from non-visual telemetry. The system further incorporates uncertainty quantification into the generated video, such as by modulating opacity, generating branching overlays, or applying probabilistic confidence encodings. Each generated prediction is recorded within a manifold journaling framework that maintains reversible mappings between the video output and its source telemetry data with bounded error tolerances.

In an aspect of an embodiment, the system incorporates contextual knowledge regarding the monitored system, including structural design parameters, operational tolerances, and historical performance data, so that predictive trajectories remain constrained to physically plausible outcomes.

In an aspect of an embodiment, the system includes a Bayesian fusion subsystem that merges geodesic priors derived from manifold geometry with short-horizon rollouts and historical trajectory archives to produce posterior distributions over possible future states.

In an aspect of an embodiment, the projection operators implement domain-specific transformations, converting vibration telemetry into visualizations of structural deformation, flow telemetry into fluid dynamic renderings, and pressure telemetry into stress distribution representations.

In an aspect of an embodiment, uncertainty quantification dynamically adjusts visual opacity in proportion to prediction confidence, such that high-certainty forecasts appear fully opaque while less certain regions are rendered with graduated transparency.

In an aspect of an embodiment, the system produces branching trajectory visualizations that diverge at critical junctures, allowing multiple plausible futures to be viewed concurrently when the posterior distribution is multimodal.

In an aspect of an embodiment, manifold journaling maintains cryptographic verification of all prediction states, thereby enabling complete forensic reconstruction of any video frame back to its originating telemetry and intermediate computation steps.

In an aspect of an embodiment, the system implements federated prediction capabilities that permit distributed cognitive substrates to exchange predictive trajectories anchored by shared multimodal landmarks while retaining local computational control.

In an aspect of an embodiment, the generated predictive video highlights potential anomalies, instabilities, or failure modes by applying visual emphasis such as color gradients, pulsation cues, or trajectory highlighting before those conditions actually occur in the physical system.

In an aspect of an embodiment, the system performs a sleep-state consolidation process that periodically evaluates predictive accuracy against newly observed telemetry and updates manifold curvature penalties to refine subsequent forecasts.

The method embodiments corresponding to the foregoing computer system embodiments perform the same functional operations in software-executed form and apply equally to the processes of receiving telemetry, encoding latent representations, forecasting trajectories, performing Bayesian fusion, generating predictive video, quantifying uncertainty, and maintaining reversible mappings; for brevity, these method versions are not restated separately in this section.

### BRIEF DESCRIPTION OF THE DRAWING FIGURES

FIG. 1 illustrates an exemplary system architecture of a latent hyperspace-based predictive video rendering system showing major subsystems and data flow paths.

FIG. 2 depicts an exemplary process flow for predictive video rendering from telemetry ingestion through encoding, forecasting, and video synthesis.

FIG. 3 illustrates a multimodal telemetry encoding subsystem showing parallel sensor pathways, synchronization buffers, and tensor-preserving encoders.

FIG. 4 depicts latent manifold prediction visualization showing geodesic trajectories, uncertainty cones, compression-pressure fields, and multimodal landmarks.

FIG. 5 illustrates Bayesian fusion operations combining geodesic priors, stochastic rollouts, and historical kernels into posterior predictive distributions.

FIG. 6 depicts exemplary projection operator transformations mapping pressure, vibration, and flow telemetry into cavitation, deformation, and turbulence visualizations.

FIG. 7 illustrates uncertainty visualization encoding using covariance ellipses, branching trajectories, and confidence-level contours within latent hyperspace.

FIG. 8 depicts manifold journaling and reversibility operations enabling reconstruction of predictive video frames back to originating telemetry data.

FIG. 9 illustrates federated prediction operations showing serialization, geometric alignment, and consensus generation across distributed cognitive substrates.

FIG. 10 depicts a nuclear reactor coolant monitoring implementation demonstrating predictive visualization of flow instabilities and cavitation onset.

FIG. 11 illustrates a sleep-state consolidation process performing offline manifold optimization and transition-operator refinement to improve future prediction accuracy.

FIG. 12 illustrates an exemplary computing environment on which an embodiment described herein may be implemented.

### DETAILED DESCRIPTION OF THE INVENTION

The inventor has conceived and reduced to practice a system and method of generating predictive, uncertainty-aware visual representations of physical system behavior from heterogeneous non-visual telemetry data by encoding such data into a latent geometric manifold and forecasting future states through geodesic, stochastic, and Bayesian computational processes.

The system is implemented for generating predictive visual representations of physical system behavior from non-visual telemetry data. The system may include a multimodal telemetry ingestion subsystem that receives and preprocesses heterogeneous sensor data originating from a monitored physical system. The telemetry may include vibration, acoustic, flow, pressure, thermal, chemical, electromagnetic, or other non-visual data streams. Each telemetry input may be received through an interface that performs conditioning, filtering, and synchronization of signals across sensor modalities. In an embodiment, the telemetry ingestion subsystem may also maintain metadata for each sensor, such as sampling rate, calibration parameters, and spatial location, to ensure consistent alignment across heterogeneous inputs.

In an embodiment, a contextual knowledge integration subsystem may incorporate known physical and operational characteristics of the monitored system. Such contextual knowledge may include structural design parameters, operational tolerances, historical performance data, and boundary conditions. The contextual data may be used to generate constraint tensors that influence downstream encoding and forecasting operations, thereby ensuring that predicted behaviors remain physically plausible and consistent with known system characteristics.

In an embodiment, a tensor-preserving multimodal encoder may transform each telemetry stream into a latent tensor representation while maintaining relationships among temporal and geometric structures. Each sensor modality may be processed through a dedicated encoding pathway optimized for that modality. For example, vibration telemetry may be transformed into spectral tensors that preserve frequency-domain structure, flow and pressure telemetry may be converted into state tensors encoding conservation relationships, thermal and chemical telemetry may be represented through reaction-diffusion tensors that retain thermodynamic balance, and acoustic telemetry may be encoded as spatial wavefield representations that preserve propagation relationships. The encoder may employ a Lorentzian autoencoder architecture configured to maintain pseudo-Riemannian geometry within the latent manifold, ensuring that causal and temporal relationships are preserved during transformation. The encoder output may consist of latent tensors that maintain dimensional consistency across modalities and that can be fused in a shared hyperspace representation.

In an embodiment, a latent hyperspace fusion engine may combine the encoded sensor representations into a unified manifold anchored by multimodal landmarks. The fusion may employ geometric operations guided by connection coefficients such as Christoffel symbols to ensure smooth transitions among submanifolds corresponding to different sensor domains. The fusion process may compute correlation tensors that quantify relationships among modalities and may produce a unified hyperspace representation denoted as M_unified, which resides in an n-dimensional real-valued space. Each point within M_unified may correspond to a latent state of the monitored system, with bijective mappings maintained between fused representations and their originating sensor modalities.

In an embodiment, a predictive rollout engine may compute forward trajectories through the latent hyperspace to forecast future states of the monitored system. The predictive process may be guided by a geometric reachability prior that estimates feasible evolution paths based on geodesic distances, curvature penalties, and compression-pressure constraints within the manifold geometry. The predictive rollout may employ learned transition operators T: M_t→M_{t+Δt} that describe how latent states evolve over time. In certain embodiments, stochastic perturbations may be applied to simulate uncertainty in predicted outcomes, where such perturbations may be expressed as σ(ε), with & representing a random variable drawn from a bounded distribution that introduces controlled variability into the latent state transitions. Multiple rollout iterations may be performed to generate short-horizon trajectory bundles representing plausible futures. The predictive process may further incorporate a historical kernel estimator that references stored archives of telemetry-to-outcome trajectories. The estimator may compute similarity metrics in latent space to identify historical states proximate to the current manifold position and may weight their contributions according to contextual similarity.

In an embodiment, a Bayesian fusion subsystem may combine outputs of the geometric prior, the short-horizon rollouts, and the historical estimators into a posterior distribution representing predicted system evolution. The Bayesian updating process may be expressed in non-limiting form as P(M_{t+τ}| all_evidence)∝P(observations|M_{t+τ})×P(M_{t+T}| priors), where the posterior probability distribution incorporates evidence from both current telemetry and stored knowledge of past system behavior. The posterior distribution may include mean and covariance parameters that quantify both expected evolution and associated uncertainty.

In an embodiment, a projection operator library may map points or trajectories in the latent manifold into corresponding coordinates within a visual manifold suitable for rendering as video. Each projection operator may be domain-specific and may enforce physical constraints relevant to that modality. For example, an operator R_vibration may transform vibration telemetry into visual representations of structural deformation, R_flow may project flow telemetry into fluid dynamic renderings, R_pressure may generate stress field visualizations, and R thermal or R_chemical may depict heat transfer or reaction front propagation. Projection operators may apply exponential and logarithmic map functions for navigation across curved manifolds, ensuring that latent-to-visual transformations maintain geometric fidelity.

In an embodiment, a video synthesis cortex may generate synthetic video sequences from projected visual manifold coordinates. The cortex may sample from the posterior distribution at successive timesteps to produce frame sequences that illustrate anticipated system evolution. Temporal coherence may be maintained through frame-to-frame constraints that ensure continuity and realistic motion. The system may render video at configurable frame rates and resolutions, and may apply uncertainty encodings within each frame. In certain embodiments, uncertainty may be represented by adjusting visual opacity according to prediction variance, with highly confident predictions rendered with full opacity and uncertain regions rendered with graduated transparency. Other uncertainty visualizations may include branching trajectory overlays, probabilistic heat maps, or motion blur effects representing temporal uncertainty.

In an embodiment, the video synthesis process may also include annotation overlays showing telemetry-derived values, confidence bounds, or regions of predicted instability or anomaly. For example, predicted anomalies may be emphasized through color gradients, pulsation effects, or highlighted trajectories that visually indicate potential system failures or instabilities before they occur in the physical system.

In an embodiment, a manifold journaling subsystem may maintain a persistent, auditable record of all prediction states and transformations applied during forecasting and video synthesis. The journaling may store manifold coordinates, operator parameters, and uncertainty metrics for each generated frame, enabling reversible reconstruction of any prediction back to its originating telemetry data. The journaling may further incorporate cryptographic verification mechanisms that authenticate prediction lineage and prevent tampering with historical records. Reversibility may be maintained through bijective rollback operators that permit navigation from a predicted state to its antecedent manifold position and ultimately to the original telemetry data.

In an embodiment, a federated prediction interface may allow distributed cognitive substrates to share predictive trajectories and associated manifold data across networked instances. Each predictive trajectory may be serialized and anchored by multimodal landmarks to preserve alignment among distributed manifolds. The interface may implement homomorphic compression for efficient data transfer and geometric alignment algorithms to ensure consistency across federated predictions. In some embodiments, federated systems may perform consensus operations that aggregate multiple forecasts into a unified prediction while preserving local computational sovereignty.

In an embodiment, the system may include operational constraints that ensure physically meaningful predictions. Predictive operations may respect causal limits represented as lightcone boundaries within Lorentzian geometry, ensuring that computed future states adhere to the temporal structure of the underlying manifold. Each predictive transformation may maintain reversibility guarantees, allowing reconstruction of prior states from forecasted trajectories with bounded error. Uncertainty quantification may be embedded throughout the processing chain so that every predicted outcome is accompanied by explicit confidence intervals or credible bounds. Projections and renderings may also enforce conservation laws, thermodynamic consistency, or other domain-specific invariants, while temporal coherence may be maintained through smooth transitions between sequential frames.

The system may incorporate diverse telemetry modalities beyond conventional industrial sensors. The multimodal telemetry ingestion subsystem may receive data from distributed acoustic sensing fibers that detect minute vibrations along kilometers of infrastructure, magnetohydrodynamic sensors monitoring plasma dynamics in fusion reactors, electrochemical sensors tracking battery degradation processes, piezoelectric strain gauges embedded in composite materials, ultrasonic thickness monitors assessing corrosion progression, radio frequency sensors detecting partial discharge in electrical equipment, and biosensors measuring enzymatic reaction rates in bioreactors. Each telemetry modality may undergo modality-specific preprocessing that preserves its information structure while enabling geometric fusion within the latent manifold. The system may dynamically weight sensor contributions based on signal quality metrics, relevance to current operational regime, and historical predictive value, ensuring that the most informative telemetry streams exert greater influence on forward trajectory computation.

Compression-pressure fields within the latent manifold may enforce operational constraints that prevent predictive trajectories from entering physically implausible regions. These fields may be implemented as local metric deformations that increase geodesic distances in directions corresponding to constraint violations, effectively creating potential barriers that deflect trajectories away from impossible states. For example, a compression field may prevent predicted temperatures from exceeding material melting points, while a pressure field may enforce conservation of mass in fluid flow predictions. The compression-pressure constraints may be derived from physical laws, engineering specifications, and empirical operational boundaries, with field strengths modulated according to proximity to constraint limits. The fields may exhibit smooth gradients to maintain differentiability for optimization processes while imposing increasingly strong penalties as trajectories approach physical impossibility boundaries.

Risk-oriented forecasting capabilities may specifically identify and emphasize potential failure modes, instabilities, or anomalous conditions in predicted system evolution. The predictive rollout engine may maintain a library of failure signatures encoded as characteristic trajectory patterns within the latent manifold, derived from historical incident data and physics-based failure analysis. During forward prediction, the system may compute similarity metrics between evolving trajectories and known failure patterns, triggering enhanced scrutiny when matches exceed threshold criteria. The video synthesis cortex may apply visual emphasis techniques to highlight regions of elevated risk, such as color gradients transitioning from nominal to critical states, pulsation effects whose frequency correlates with proximity to failure, or trajectory ribbons whose width represents the range of possible failure progressions. These risk visualizations may appear in the predictive video stream before the corresponding physical manifestation, providing operators with actionable lead time for preventive intervention.

The Bayesian fusion process may implement hierarchical probability structures that account for multiple levels of uncertainty in predictive forecasting. At the lowest level, measurement uncertainty from sensor noise and calibration errors may be propagated through the encoding process as variance parameters attached to latent tensors. At an intermediate level, model uncertainty arising from approximate transition operators and incomplete system knowledge may be represented through ensemble methods that maintain multiple hypothesis trajectories. At the highest level, scenario uncertainty reflecting unknown future operating conditions or external disturbances may be captured through branching trajectory bundles that diverge at critical decision points. The hierarchical uncertainty structure may be collapsed into a unified posterior distribution through marginalization operations, with each uncertainty level contributing to the final confidence bounds rendered in the predictive video output.

The contextual knowledge integration subsystem may maintain a structured repository of system-specific information that constrains and informs predictive operations throughout the processing pipeline. Design specifications may include material properties such as Young's modulus, yield strength, and fatigue limits that bound structural deformation predictions, thermodynamic parameters such as heat capacity, thermal conductivity, and phase transition temperatures that constrain thermal evolution forecasts, and fluid dynamic characteristics such as Reynolds number thresholds, cavitation indices, and pressure-velocity relationships that govern flow predictions. Operational state information may encompass current setpoints, control valve positions, pump speeds, and process variables that define the starting conditions for predictive rollouts. Historical performance data may provide empirical baselines for normal operation, known degradation patterns, and previously observed failure modes that inform trajectory likelihood estimates. The contextual knowledge may be encoded as constraint tensors that modulate the action of transition operators, ensuring that predicted states remain consistent with known system properties.

Through hierarchical storage architecture, the manifold journaling subsystem may balance comprehensive audit trails with computational efficiency. At the finest granularity, the system may record complete manifold states at critical prediction points, including all tensor coordinates, operator parameters, and uncertainty metrics. At intermediate levels, the system may store differential updates that capture state changes between successive prediction steps, reducing storage requirements while maintaining reconstruction capability. At the coarsest level, the system may maintain checkpoint summaries that provide rapid access to major prediction milestones without full detail preservation. The journaling hierarchy may support variable-resolution reconstruction, where operators can perform quick approximate rollbacks for routine verification or detailed forensic analysis for incident investigation. Cryptographic hashing may be applied at each storage level to ensure tamper-evident audit trails that support regulatory compliance and liability assessment.

During sleep-state consolidation, sophisticated optimization algorithms may refine predictive models based on accumulated prediction-outcome discrepancies. The consolidation may employ gradient-based optimization to adjust manifold curvature parameters in regions where prediction errors exhibit systematic bias, stochastic optimization to explore alternative geometric configurations that might better capture system dynamics, and reinforcement learning techniques that reward parameter adjustments leading to improved long-term prediction accuracy. The optimization process may maintain separate learning rates for different components of the predictive system, with geometric parameters updated conservatively to preserve stability while transition operators adapt more rapidly to capture evolving system behavior. The consolidation may also perform automated hyperparameter tuning, adjusting factors such as prediction horizon length, perturbation magnitude, and historical weighting schemes based on observed performance metrics.

In certain embodiments, the system may perform adaptive optimization of its predictive operators. For example, a consolidation process may periodically evaluate forecast accuracy by comparing predicted trajectories against subsequently observed telemetry and may update geometric parameters, such as curvature penalties, to improve predictive fidelity. Such adaptive refinement ensures that the system remains responsive to long-term changes in system dynamics and maintains alignment between learned manifold structure and evolving physical conditions.

In operation, the described system may receive continuous telemetry from one or more monitored systems, encode the data into latent tensors, compute predicted evolutions in latent hyperspace, fuse probabilistic estimates using Bayesian methods, and render predictive video sequences that illustrate future system behavior. All intermediate and final states may be recorded in an auditable manifold journal that ensures traceability and reversibility. In some embodiments, multiple instances of the system may collaborate to produce federated, consensus-based forecasts, enabling distributed situational awareness across multiple monitored systems or networked environments.

Through these combined features, the system enables machine-driven synthesis of predictive, uncertainty-aware video directly from non-visual telemetry streams, providing operators with interpretable visualizations of anticipated physical system evolution grounded in geometric, auditable computation.

In various embodiments, the system described herein may operate as or within a persistent cognitive substrate configured for continual perception, reasoning, and synthesis of physical system representations. Within this substrate, the multimodal telemetry ingestion layer, contextual knowledge integration system, tensor-preserving encoder, latent hyperspace fusion engine, predictive rollout engine, Bayesian fusion system, projection operator library, video synthesis cortex, manifold journaling subsystem, and federated prediction interface collectively function as coordinated cognitive processes. The persistent cognitive substrate maintains continuity of learned manifold structure and prediction history across operational cycles, enabling it to accumulate experience from prior telemetry, adapt forecasting parameters, and refine uncertainty models over time. Such persistence allows the substrate to exhibit durable cognition-retaining geometric understanding of physical systems, updating manifold curvature penalties through sleep-state optimization, and sustaining auditable reasoning chains between sensor inputs and rendered visual predictions. In this way, the disclosed architecture may be regarded as a machine-implemented cognitive framework that persistently encodes, forecasts, and visualizes the evolving behavior of monitored physical systems.

In a non-limiting use case example, a system may be applied to monitoring a nuclear reactor coolant loop in an energy-generation facility. A plurality of sensors may continuously provide vibration, pressure, flow, and acoustic telemetry from coolant pumps, piping structures, and reactor vessel internals. The telemetry ingestion subsystem may receive these data streams and synchronize them into temporally aligned sequences. The contextual knowledge integration subsystem may incorporate reactor-specific design information, including hydraulic geometry, operational limits, and historical flow instability events. Encoded telemetry may be transformed within a tensor-preserving manifold that maintains correlations between thermal and mechanical variables. The predictive rollout engine may compute latent trajectories representing future states of coolant flow and pressure fields, using geodesic forecasting constrained by thermodynamic conservation. Stochastic perturbations σ(ε) may be applied to model small variations in coolant density and pump vibration. The Bayesian fusion subsystem may merge the geometric forecasts with historical coolant instability data to generate a posterior distribution of possible flow conditions. The video synthesis cortex may render a predictive sequence showing the expected evolution of turbulence, cavitation onset, or pump vibration amplification several seconds before such conditions would arise physically. Areas of higher uncertainty may appear semi-transparent, while regions predicted to approach cavitation thresholds may pulse in color intensity, alerting operators to potential instabilities in time for preventive action.

In another non-limiting use case example, a system may be utilized for structural health prediction in aerospace applications. Acoustic and vibration sensors distributed across an aircraft wing may provide continuous telemetry reflecting dynamic load distributions during flight. The telemetry ingestion subsystem may process these signals into frequency-domain tensors, while contextual data may include the wing's material composition, geometry, and fatigue history. The multimodal encoder may embed these inputs into a latent manifold representing the stress-strain evolution of the airframe. The predictive rollout engine may project the latent state forward in time, computing potential deformation and crack initiation trajectories using transition operators T: M_t→M_{t+Δt}. Bayesian fusion may integrate priors derived from historical flight cycles and laboratory fatigue testing, generating posterior distributions of expected structural states over future flight intervals. The projection operators may convert predicted latent configurations into visual manifold coordinates that depict surface deformation and crack propagation paths. The rendered synthetic video may show how localized stress concentrations evolve along the wing structure, with uncertainty encoded through opacity gradients and branching overlays indicating alternative failure progressions under varying load conditions. The manifold journaling subsystem may maintain full reversibility between each predicted frame and the original telemetry, allowing investigators to trace any predicted anomaly back to its precise sensor origin and geometric context.

In another non-limiting use case example, a Persistent Cognitive Machine (PCM) may be deployed to monitor and forecast the operational state of a large-scale industrial manufacturing complex. The PCM may continuously ingest heterogeneous non-visual telemetry including vibration and acoustic signals from rotating machinery, flow and pressure measurements from pneumatic and hydraulic lines, thermal and chemical readings from process reactors, and electromagnetic telemetry from high-power electrical systems. The multimodal telemetry ingestion layer may synchronize and condition these sensor streams, while the contextual knowledge integration system may encode factory layout, machine design data, and production schedules as constraint tensors. The tensor-preserving multimodal encoder may embed the synchronized telemetry into a unified latent hyperspace maintaining correlations among mechanical, thermal, and electrical domains.

The latent hyperspace fusion engine of the PCM may establish multimodal landmarks corresponding to critical plant subsystems and may compute cross-modal correlation tensors to quantify coupled behaviors between them. A predictive rollout engine may then simulate short-horizon system dynamics within the latent manifold, applying geodesic reachability constraints and stochastic perturbations to represent uncertainty in process evolution. These forecasts may be merged by a Bayesian fusion system to yield posterior distributions over probable future operational states.

The projection operator library may map these latent predictions into a visual manifold representing the physical plant, generating video sequences that depict anticipated temperature gradients across reactors, expected vibration modes of rotating shafts, or pressure oscillations within fluid lines. The video synthesis cortex may render predictive visualizations annotated with uncertainty encodings, which are regions of high variance appearing semi-transparent or overlaid with probabilistic heat maps. The manifold journaling subsystem may record each prediction state, operator parameter, and uncertainty metric, enabling reversible reconstruction of any visualization back to its originating telemetry.

Over time, the persistent cognitive substrate of the PCM may refine its internal geometric representations by comparing predicted outcomes with observed telemetry, adjusting curvature penalties and transition operators to improve subsequent forecasts. In distributed environments, multiple PCM instances located at different facilities may exchange predictive trajectories through the federated prediction interface, aligning their multimodal landmarks to share situational awareness across an enterprise network. Through these integrated processes, the PCM may provide operators with auditable, uncertainty-aware video forecasts of factory-wide conditions, enabling proactive maintenance, anomaly avoidance, and optimization of complex industrial operations.

In another non-limiting use case example, a system may be applied to biomedical monitoring of cardiovascular flow dynamics using non-invasive pressure and flow telemetry from wearable or implanted sensors. The telemetry ingestion subsystem may acquire real-time hemodynamic data, including arterial pressure waveforms, flow velocities, and localized temperature variations. Contextual information such as vascular geometry, patient-specific physiological parameters, and prior diagnostic imaging data may be incorporated to constrain forecasts within anatomically plausible limits. The multimodal encoder may represent these signals as latent tensors preserving relationships among pulsatile flow, vessel compliance, and metabolic feedback. The predictive rollout engine may compute short-horizon trajectories representing the expected evolution of flow distribution and pressure gradients through arterial segments. The stochastic perturbation σ(ε) may account for variations in heart rate or external stimuli. Bayesian fusion may combine these results with stored patient data to yield a probabilistic prediction of near-future cardiovascular states. Projection operators may map these latent predictions into visual manifold coordinates that correspond to a three-dimensional representation of vascular flow. The video synthesis cortex may generate predictive sequences showing how pressure waves propagate through arteries, highlighting regions where turbulence or occlusion risk is increasing. Uncertainty visualization may use color gradients or localized transparency to illustrate the confidence of each prediction. The predictive video may thus allow clinicians to observe potential onset of arrhythmia or vascular blockage several minutes in advance, with each rendered forecast being traceable to its underlying telemetry and model configuration through manifold journaling.

In other non-limiting use case scenarios, the described system may be applied across a broad range of scientific, industrial, and environmental domains. For example, in hydroelectric installations, flow and pressure telemetry from turbines and dam structures may be used to forecast cavitation onset or stress accumulation within submerged components. In urban infrastructure, distributed flow and acoustic sensors in water or gas networks may enable predictive visualization of leak propagation or rupture events. In environmental sciences, atmospheric or oceanographic telemetry may be transformed into predictive video illustrating the evolution of storm systems, pollutant dispersion, or current dynamics. Geological and seismological data streams may be converted into visual forecasts of stress accumulation along fault lines to aid in early earthquake risk assessment. In manufacturing and energy systems, predictive rendering of chemical or thermal telemetry may allow operators to visualize impending process instabilities or reaction front dynamics in real time. These and other applications illustrate that the system may be adapted wherever non-visual telemetry describes a physical process whose future state can be forecast and meaningfully visualized within a latent geometric framework.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, “persistent cognitive substrate” refers to a machine-implemented computational framework that continuously maintains learned manifold structures, prediction histories, and contextual knowledge across operational cycles to support ongoing perception, reasoning, and predictive synthesis.

As used herein, “latent manifold” refers to a geometric representation of system states within a high-dimensional latent space in which distances, curvatures, and trajectories correspond to relationships among encoded telemetry data.

As used herein, “latent hyperspace” refers to the unified geometric domain resulting from fusing multiple latent manifolds corresponding to different sensor modalities into a single, tensor-consistent representational space.

As used herein, “multimodal telemetry” refers to heterogeneous, non-visual sensor data streams acquired from multiple sensing modalities such as vibration, acoustic, flow, pressure, thermal, chemical, electromagnetic, or biosensor sources.

As used herein, “telemetry ingestion layer” refers to the subsystem configured to receive, condition, synchronize, and temporally align multimodal telemetry data for subsequent encoding.

As used herein, “tensor-preserving encoder” refers to a computational mechanism that transforms raw telemetry into latent tensor representations while preserving structural, temporal, and physical relationships inherent in the source data.

As used herein, “latent hyperspace fusion engine” refers to a subsystem that combines modality-specific latent tensors into a unified manifold representation using geometric operations that maintain cross-modal correspondence and differentiability.

As used herein, “predictive rollout engine” refers to the subsystem that computes forward trajectories within latent hyperspace using at least one of geodesic forecasting, stochastic perturbation, or historical trajectory matching to forecast future system states.

As used herein, “geodesic forecasting” refers to the process of estimating future system states by computing trajectories of minimal geodesic distance through a latent manifold according to its learned curvature and metric tensor.

As used herein, “compression-pressure field” refers to a manifold constraint function that penalizes trajectories entering regions of high stress, instability, or physical implausibility within the latent hyperspace.

As used herein, “Bayesian fusion system” refers to a probabilistic computation process that combines geometric priors, stochastic rollouts, and historical kernel estimators into posterior probability distributions representing predicted system evolution.

As used herein, “projection operator” refers to a mathematically defined transformation that maps points or trajectories from latent hyperspace into coordinates of a visual manifold suitable for video rendering, while maintaining physical constraints and differentiability.

As used herein, “video synthesis cortex” refers to a processor-implemented rendering subsystem that generates synthetic video frames or sequences from visual manifold coordinates, encoding uncertainty and predictive confidence into the visual output.

As used herein, “uncertainty encoding” refers to the visual representation of predictive uncertainty in synthetic video, expressed through opacity gradients, probabilistic overlays, branching trajectories, or other confidence-indicating visual features.

As used herein, “manifold journaling” refers to the process of persistently recording manifold coordinates, operator parameters, and uncertainty metrics to enable reversible reconstruction of predictive results back to original telemetry inputs.

As used herein, “federated prediction interface” refers to the subsystem enabling distributed instances of a persistent cognitive substrate to exchange, align, and aggregate predictive trajectories across networked environments while maintaining local computational control.

As used herein, “sleep-state consolidation” refers to an offline or background process in which a persistent cognitive substrate suspends real-time prediction to analyze archived prediction-outcome data, refine manifold geometry, and update transition operators based on empirical performance.

As used herein, “transition operator” refers to a learned mapping function that predicts how a latent state Mₜ transitions to a future state Mₜ₊Δₜ within latent hyperspace based on temporal dynamics and contextual constraints.

As used herein, “multimodal landmark” refers to a reference point within latent hyperspace corresponding to a known or empirically verified system condition used to anchor geometric alignment among sensor modalities or distributed systems.

As used herein, “posterior distribution” refers to the probabilistic representation of future system states computed through Bayesian fusion of prior geometric estimates, stochastic rollouts, and historical trajectory evidence.

As used herein, “predictive synthetic video” refers to a machine-generated video sequence visually representing forecasted evolution of a physical system derived directly from non-visual telemetry data encoded in latent hyperspace.

As used herein, “reversibility” refers to the capability of reconstructing telemetry data or intermediate computational states from generated predictive outputs using stored manifold mappings and operator parameters.

As used herein, “persistent auditability” refers to the property that every predictive output, trajectory, or video frame can be cryptographically traced and reconstructed through manifold journaling to verify computational lineage.

As used herein, the term “comprising” is intended to be inclusive and open-ended, permitting inclusion of additional elements or steps beyond those expressly recited.

As used herein, “in an embodiment” indicates a non-limiting example and does not require or imply that all embodiments include the described feature.

As used herein, “machine-implemented” or “computer-implemented” refers to operations executed by processors on machine-readable data without human mental performance.

### Conceptual Architecture of a Latent Hyperspace-Based Predictive Video Rendering System

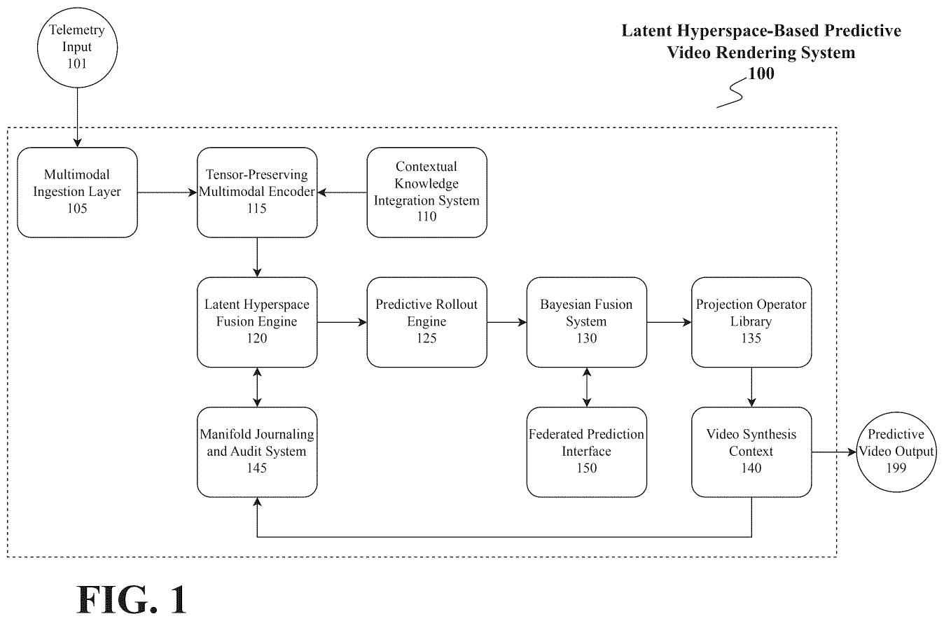

FIG. 1 is a block diagram illustrating exemplary architecture of a latent hyperspace-based predictive video rendering system, in an embodiment. A system 100 receives heterogeneous sensor data from telemetry sources 101 comprising vibration, acoustic, flow, pressure, thermal, chemical, and electromagnetic sensors that monitor a physical system. A multimodal telemetry ingestion layer 105 performs temporal alignment and signal conditioning on incoming telemetry streams, synchronizing data across different sampling rates and applying modality-specific filtering operations. A contextual knowledge integration system 110 incorporates design parameters, operational tolerances, and historical performance data that may constrain predictive operations to physically plausible outcomes. The ingestion layer 105 and knowledge integration system 110 provide conditioned telemetry and context tensors to a tensor-preserving multimodal encoder 115 that transforms each sensor modality through dedicated encoding pathways, such as vibration telemetry to spectral feature tensors and flow telemetry to fluid dynamic state vectors, while maintaining geometric structure relationships through a Lorentzian autoencoder architecture.

A latent hyperspace fusion engine 120 applies geometric operations guided by connection coefficients to combine encoded tensor representations into a unified manifold representation anchored by multimodal landmarks. The fusion engine 120 computes cross-modal correlation tensors and maintains bijective mappings between fused representations and their originating sensor modalities, producing a unified hyperspace representation that preserves relationships across heterogeneous data streams. A predictive rollout engine 125 operates on the unified manifold state to compute forward trajectories through three complementary mechanisms: a geometric reachability prior that estimates feasible evolution paths based on geodesic distances and curvature penalties, short-horizon latent dynamics that apply learned transition operators with stochastic perturbations to model uncertainty, and a historical kernel estimator that queries archived trajectory data to identify similar past states. The predictive rollout engine 125 may generate multiple trajectory bundles representing plausible future evolutions of the monitored system over configurable prediction horizons.

A Bayesian fusion system 130 receives geometric priors, stochastic rollout results, and historical kernel estimates from predictive rollout engine 125 to compute posterior distributions over predicted system states. The Bayesian fusion system 130 combines evidence through probabilistic updating operations that may be expressed as posterior probability proportional to the product of likelihood and prior distributions, generating mean trajectories with associated covariance structures that quantify prediction uncertainty. A projection operator library 135 receives posterior distributions from Bayesian fusion system 130 and applies domain-specific transformations that map latent hyperspace coordinates to visual manifold representations suitable for rendering. The projection operator library 135 may implement specialized operators such as transforming vibration telemetry into structural deformation visualizations or pressure telemetry into stress field renderings, while maintaining physical constraints and differentiability properties through exponential and logarithmic map functions.

A video synthesis cortex 140 samples from projected visual manifold coordinates to generate synthetic video sequences representing predicted future states of the monitored system. The video synthesis cortex 140 incorporates uncertainty quantification through visual encoding mechanisms such as opacity gradients proportional to prediction variance, branching trajectory overlays for multimodal distributions, and annotation subsystems that highlight regions of potential instability or anomaly. The video synthesis cortex 140 maintains temporal coherence through frame-to-frame constraints and renders at configurable frame rates to produce predictive video output 199 that provides interpretable visualization of anticipated system evolution. Throughout operation, a manifold journaling and audit system 145 maintains reversible mappings between generated predictions and source telemetry, recording manifold coordinates, operator parameters, and uncertainty metrics with cryptographic verification to support forensic reconstruction of any prediction back to its originating sensor inputs.

A federated prediction interface 150 may serialize local predictive trajectories for sharing across distributed system instances, implementing homomorphic compression and geometric alignment protocols to maintain consistency while preserving computational sovereignty. The federated prediction interface 150 supports consensus operations that aggregate predictions from multiple nodes anchored by shared multimodal landmarks, enabling collaborative prediction generation across networked deployments. A historical trajectory archive provides past telemetry-to-outcome data to predictive rollout engine 125 through similarity-based retrieval operations, supporting the historical kernel estimator in identifying relevant prior system behaviors. The architecture supports bidirectional data flows, with primary paths carrying telemetry through encoding, prediction, and synthesis stages, while auxiliary paths provide feedback for optimization and journaling connections that maintain audit trails across all computational transformations.

In operation, data flow through system 100 proceeds from telemetry acquisition through predictive synthesis in distinct computational stages. Telemetry sources 101 generate continuous sensor measurements that multimodal telemetry ingestion layer 105 receives and conditions, producing temporally aligned data streams that flow concurrently to tensor-preserving multimodal encoder 115 along with contextual constraints from knowledge integration system 110. The encoder 115 transforms these inputs into latent tensor representations that latent hyperspace fusion engine 120 combines into a unified manifold state, which predictive rollout engine 125 uses to compute multiple forward trajectories through geometric, stochastic, and historical estimation pathways. These trajectory estimates converge at Bayesian fusion system 130 for probabilistic combination into posterior distributions that projection operator library 135 maps to visual manifold coordinates, from which video synthesis cortex 140 generates frames of predictive video output 199. Parallel to this primary flow, manifold journaling and audit system 145 captures intermediate states at each transformation stage to maintain reversible mappings, while federated prediction interface 150 may exchange trajectory data with remote system instances for collaborative prediction generation.

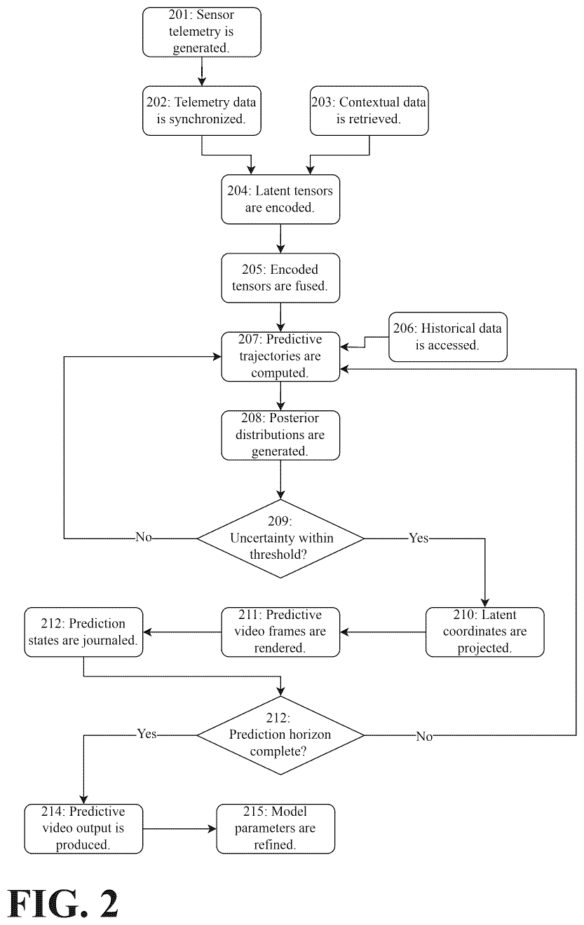

FIG. 2 is a flow diagram illustrating exemplary predictive video rendering of a latent hyperspace-based predictive rendering video system 100, in an embodiment. The process initiates when telemetry sources 101 generate sensor data streams from a monitored physical system 201. A multimodal telemetry ingestion layer 105 receives the heterogeneous sensor streams and performs temporal alignment and signal conditioning to produce synchronized telemetry data 202. Concurrently, a contextual knowledge integration system 110 retrieves design parameters, operational tolerances, and historical performance data relevant to the monitored system 203. A tensor-preserving multimodal encoder 115 receives both conditioned telemetry and contextual constraints to generate latent tensor representations that preserve geometric and temporal relationships 204.

A latent hyperspace fusion engine 120 applies geometric operations guided by connection coefficients to combine encoded tensor representations into a unified manifold state comprising embedded modal submanifolds 205. A historical trajectory archive provides relevant past telemetry-to-outcome data that may inform subsequent prediction operations 206. A predictive rollout engine 125 operates on the unified manifold state and historical data to compute forward trajectories through geodesic forecasting, stochastic perturbations, and kernel-based similarity matching 207. A Bayesian fusion system 130 receives the multiple trajectory estimates and combines them through probabilistic updating to generate posterior distributions with uncertainty quantification 208.

The system evaluates whether prediction uncertainty falls within acceptable thresholds for reliable visualization 209. If uncertainty exceeds the threshold, the process returns to predictive rollout engine 125 for additional trajectory refinement using adjusted parameters or extended sampling. When uncertainty satisfies threshold criteria, a projection operator library 135 applies domain-specific transformations to map latent hyperspace coordinates into visual manifold representations 210. A video synthesis cortex 140 samples from the visual manifold coordinates and generates synthetic video frames with uncertainty encoding through opacity gradients or branching overlays 211. A manifold journaling and audit system 145 records the current prediction state including manifold coordinates, operator parameters, and transformation metadata to maintain reversible mappings 212.

The system determines whether the prediction horizon is complete by comparing current prediction time against the configured forecast duration 213. If the prediction horizon remains incomplete, the process returns to predictive rollout engine 125 to compute trajectories for subsequent time steps, maintaining temporal continuity across the prediction sequence. When the prediction horizon is satisfied, the accumulated frames constitute predictive video output 199 that visualizes anticipated system evolution 214. In certain embodiments, a sleep-state consolidation process may periodically analyze prediction accuracy against observed outcomes to refine manifold curvature penalties and transition operators, with refined parameters feeding back to predictive rollout engine 125 for improved future predictions.

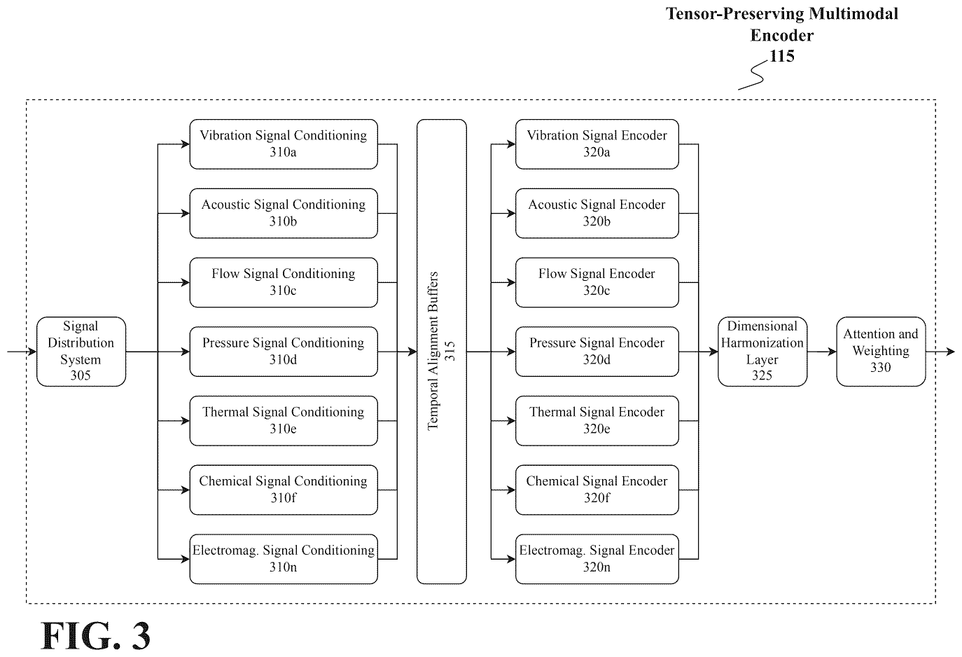

FIG. 3 is a block diagram illustrating exemplary architecture of a multimodal telemetry encoding subsystem of a latent hyperspace-based predictive video rendering system, in an embodiment. A tensor-preserving multimodal encoder 115 receives conditioned telemetry data from a multimodal telemetry ingestion layer 105 and contextual constraint data from a contextual knowledge integration system 110. Within encoder 115, a signal distribution subsystem 305 allocates incoming telemetry streams to modality-specific processing pathways according to sensor type, directing vibration telemetry to signal conditioning block 310a, acoustic telemetry to block 310b, flow telemetry to block 310c, pressure telemetry to block 310d, thermal telemetry to block 310e, chemical telemetry to block 310f, and electromagnetic telemetry to block 310n. Each signal conditioning block performs preprocessing operations tailored to its modality, including filtering, normalization, and noise reduction. For example, block 310a performs spectral decomposition for vibration signals, block 310b applies wavelet transforms to acoustic data, block 310c implements Reynolds decomposition for flow measurements, and block 310n processes electromagnetic telemetry through field component separation.

Temporal alignment buffers 315 receive conditioned signals from blocks 310a through 310n and synchronize data streams across different sampling rates and acquisition latencies to preserve temporal coherence and causal ordering among modalities. The buffers may support sampling frequencies ranging from sub-Hertz for slow thermal processes to megahertz rates for acoustic emissions, applying dynamic resampling and phase-correction techniques to maintain alignment across all input channels.

Synchronized telemetry data flows from alignment buffers 315 to modality-specific encoders 320a through 320n, which transform aligned sensor data into latent tensor representations executed by processor-implemented tensor operations. Encoder 320a generates spectral feature tensors from vibration data that preserve frequency-domain structure; encoder 320b produces acoustic wavefield representations that maintain spatial propagation characteristics; encoder 320c creates fluid dynamic state vectors that encode conservation laws; encoder 320d generates pressure field tensors incorporating compressibility factors; encoder 320e produces reaction-diffusion tensors maintaining thermodynamic consistency; encoder 320f produces chemical signature tensors; and encoder 320n creates electromagnetic field tensors preserving relationships governed by Maxwell's equations.

A dimensional harmonization layer 325 receives heterogeneous latent tensors from encoders 320a through 320n and projects them into a common latent dimensional space while retaining their geometric integrity through parallel transport operations. The harmonization layer may employ non-limiting alignment techniques such as Procrustes manifold alignment, canonical correlation embedding, or graph Laplacian matching to preserve local neighborhood relationships and establish cross-modal correspondences through shared anchor points in the latent space.

A modal attention and weighting mechanism 330 computes dynamic contribution weights for each modality based on signal quality metrics, contextual relevance scores, and cross-modal correlation strengths. In other embodiments, the attention and weighting mechanism 330 may be applied before harmonization to pre-filter or normalize modality contributions based on signal quality metrics prior to manifold alignment The mechanism generates attention coefficients that modulate the influence of each modal tensor within the harmonized space, assigning greater weight to modalities exhibiting strong predictive features and lower uncertainty. The resulting weighted tensors are combined to produce a unified latent tensor output that maintains bijective mappings to the source modalities while preserving the pseudo-Riemannian geometry required for subsequent predictive processing within the latent hyperspace fusion engine 120.

The unified latent tensor output thus serves as the input to the latent hyperspace fusion engine, ensuring that all encoded sensor modalities are geometrically consistent and temporally synchronized for downstream predictive trajectory computation and Bayesian fusion.

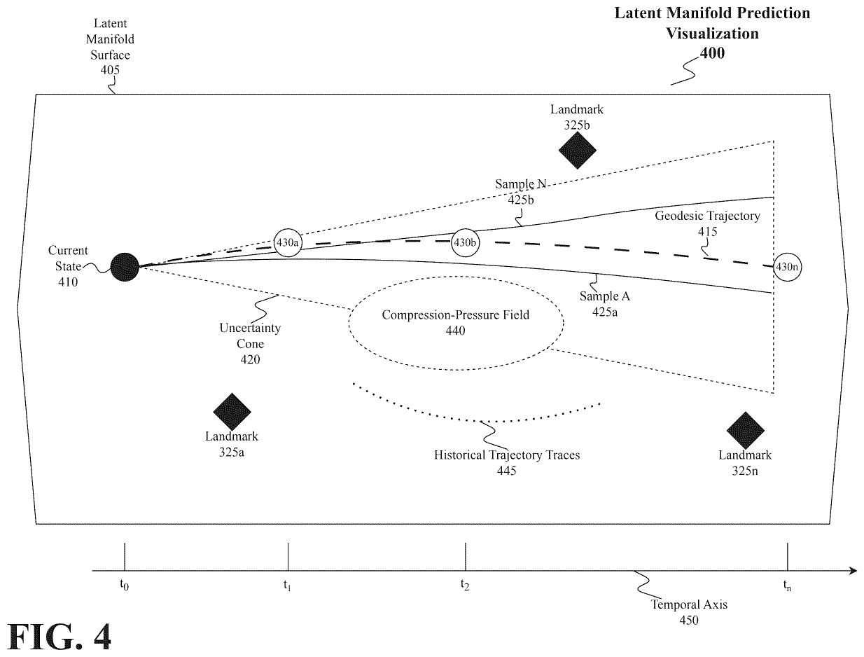

FIG. 4 is a technical diagram illustrating latent manifold prediction visualization illustrating geodesic trajectories, uncertainty cone expansion, compression-pressure constraints, and multimodal landmarks within latent hyperspace, in an embodiment. Sizes, shapes, and angles are not to scale and may be simplified for clarity. Operations are performed by machine-implemented processes as described herein and should not be construed as mental steps.

A latent manifold surface 405 represents the geometric space in which system states evolve, with grid overlays indicating local coordinate structure and curvature properties of the pseudo-Riemannian geometry. A current state point 410 marks the present position of a monitored physical system within the manifold at time to, serving as the origin for predictive trajectory computation. From current state 410, a geodesic trajectory 415 extends through manifold 405 following the path of minimal geodesic distance, representing the most probable evolution of the system state based on the geometric structure of the latent space. The trajectory 415 may be computed by a predictive rollout engine 125 executing machine-implemented tensor operations that utilize connection coefficients derived from manifold metric tensors, such as Christoffel symbols, and may incorporate learned transition operators that respect curvature and causal constraints.

An uncertainty cone 420 expands from current state 410 to encompass a range of possible future states, with cone width increasing over the prediction horizon to reflect cumulative uncertainty in forward predictions. The uncertainty cone 420 may be generated through stochastic perturbation kernels that sample from probability distributions calibrated to observed system variability and measurement noise characteristics. Within uncertainty cone 420, multiple stochastic trajectory samples 425a-n illustrate alternative evolution paths that the system may follow, each representing a plausible outcome derived from distinct realizations of random perturbations and model variance. Predicted state points 430a,b, . . . n positioned along geodesic trajectory 415 indicate discrete temporal snapshots at successive times t₁, t₂, . . . tₙ, with decreasing opacity used to encode diminishing prediction confidence as temporal distance from to increases.

Multimodal landmarks 435a-n are distributed across manifold surface 405 and serve as reference anchors that maintain geometric alignment among heterogeneous sensor modalities. These landmarks may correspond to empirically known system states, operational boundaries, or regions where multiple sensor modalities exhibit strong correlation, providing geometric constraints that guide trajectory prediction. A compression-pressure field 440 defines a region of modified geodesic flow influencing trajectory evolution and representing physical constraints such as operational limits, safety boundaries, or areas of increased system stress. The compression-pressure field 440 may apply curvature-based penalties or local metric deformations that deflect trajectories away from physically implausible regions while maintaining differentiability for gradient-based optimization processes executed by predictive rollout engine 125.

Historical trajectory traces 445 depict previously observed system evolution paths stored in a historical trajectory archive, providing empirical data for kernel-based similarity matching and trajectory refinement. The historical traces 445 may be weighted according to their proximity to current state 410 within latent space, enabling closer trajectories to contribute more strongly to posterior probability estimates generated by a Bayesian fusion system 130. A temporal axis 450 indicates the progression of time from t₀ through t₁ to tₙ, defining the prediction horizon over which future system states are forecast.

The combination of geodesic trajectory 415, uncertainty cone 420, stochastic trajectory samples 425a-n, predicted state points 430a-n, multimodal landmarks 435a-n, compression-pressure field 440, and historical traces 445 collectively forms a predictive visualization framework within the latent manifold. This framework enables operators to interpret both the expected system evolution and the associated uncertainty bounds derived from geometric, stochastic, and historical evidence sources. The visualization depicted in FIG. 4 may be generated by the video synthesis cortex 140 using manifold coordinates and posterior distributions produced by predictive rollout engine 125 and Bayesian fusion system 130.

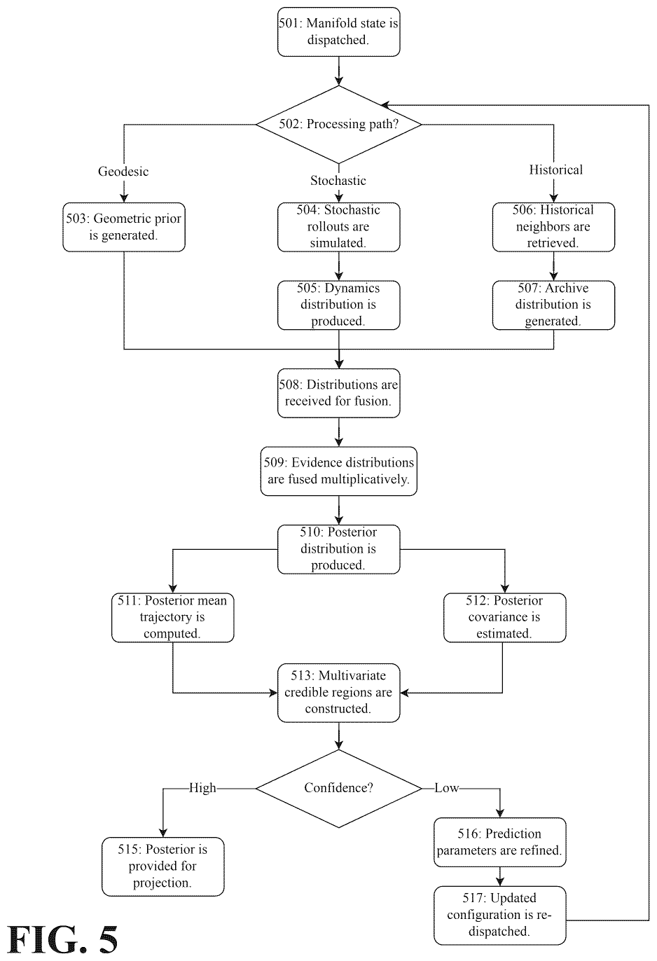

FIG. 5 is a flow diagram illustrating exemplary Bayesian fusion within a latent hyperspace-based predictive video rendering system 100, in an embodiment. The process initiates when a unified manifold state from latent hyperspace fusion engine 120 enters a parallel prediction pathway distributor that routes the current system state to three concurrent prediction mechanisms 501. A geodesic prior computation process receives the manifold state and calculates geometric reachability constraints based on manifold curvature and geodesic distances 502. The geodesic prior computation process generates a prior probability distribution P(M_{t+τ}| geometry) representing feasible state evolution paths constrained by the latent manifold's geometric structure 503. Concurrently, a stochastic rollout generation process receives the same manifold state and performs multiple forward simulations with randomized perturbations applying transition operators T: M_t→M_{t+Δt} 504. The stochastic rollout process produces a short-horizon trajectory bundle distribution P(M_{t+τ}| dynamics) that captures uncertainty arising from system variability and modeling approximations 505.

Simultaneously, a historical kernel matching process queries a trajectory archive to identify past system evolutions similar to the current state using latent space similarity metrics 506. The historical kernel matching process generates a similarity-weighted distribution P(M_{t+τ}| archive) based on observed past behaviors from retrieved trajectories 507. A Bayesian fusion engine 130 receives the three probability distributions from the geodesic prior, stochastic rollout, and historical kernel processes 508. Bayesian fusion engine combines evidence using a product-of-experts formulation:

$$log P ( M\_ \{ t + τ \} \vert E ) ∝ α\_geo \cdot log P ( M\_ \{ t + τ \} \vert geometry ) + α\_dyn \cdot log P ( M\_ \{ t + τ \} \vert dynamics ) + α\_hist \cdot log P ( M\_ \{ t + τ \} \vert archive ) ,$$

where α_geo, α_dyn, and α_hist are confidence weights learned or configured from validation statistic 509. A posterior distribution generator produces a unified probability distribution integrating geometric constraints, dynamic predictions, and historical patterns from the Bayesian update 510.

A mean trajectory extractor processes the posterior distribution to compute the expected evolution path μ(M_{t+τ}) representing the most likely system trajectory 511. A covariance structure computation process analyzes the posterior distribution to determine the uncertainty matrix Σ(M_{t+τ}) quantifying prediction variance across manifold dimensions 512. A 15 confidence interval generator receives both the mean trajectory and covariance structure to construct prediction bounds [μ−nσ, μ+nσ] where n represents the desired confidence level 513. A variance quality check evaluates whether the computed confidence intervals fall within acceptable thresholds for reliable visualization 514. When variance quality check 514 confirms sufficient confidence levels, the posterior distribution with uncertainty bounds flows to an output stage that provides the results to projection operator library 135 for visual manifold transformation 515. When variance quality check 514 identifies excessive uncertainty, a parameter refinement process adjusts prediction parameters including horizon length, perturbation magnitude, or historical weighting factors 516. The refined parameters return to parallel prediction pathway distributor 501 to initiate another fusion cycle with updated configuration 517.

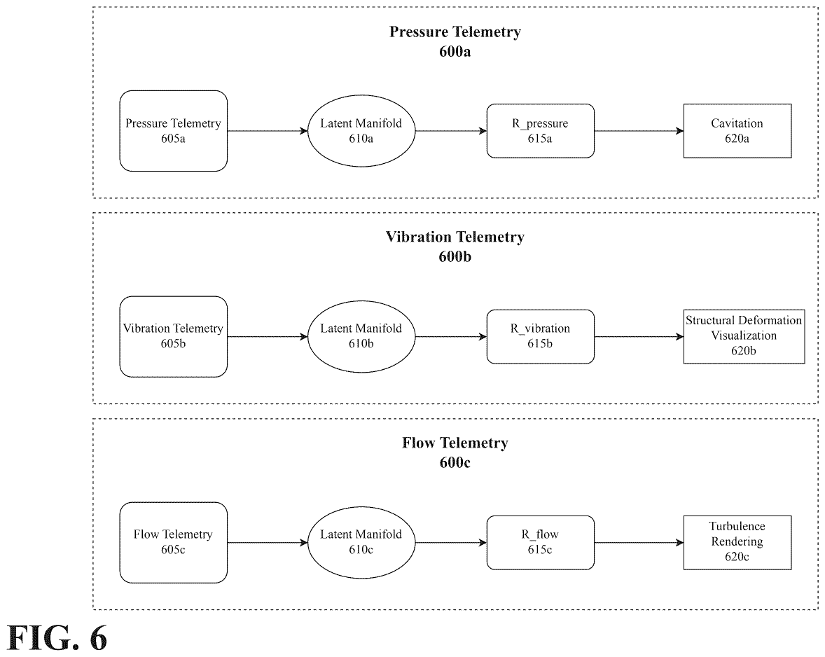

FIG. 6 is a technical diagram illustrating exemplary domain-specific projection operator transformations including pressure-to-cavitation visualization, vibration-to-structural deformation, and flow-to-turbulence rendering, in an embodiment. A pressure telemetry input 605a contains differential pressure measurements, frequency components, and phase information from pressure sensors monitoring a fluid system. The pressure telemetry 605a is encoded by a tensor-preserving multimodal encoder 115 and combined by latent hyperspace fusion engine 120 to produce a latent manifold representation 610a in which pressure data resides as tensor coordinates preserving thermodynamic relationships. A pressure projection operator R_pressure 615a receives the latent pressure representation and applies domain-specific transformations that map pressure field tensors to visual coordinates suitable for cavitation rendering. In an embodiment, a cavitation index σ=(p_local−p_vap)/(0.5 ρ v\hat{ }2) or an equivalent metric is computed from the encoded tensors, and glyph radius and opacity are parameterized as monotone functions of σ and local pressure differentials. The operator 615a generates a cavitation visualization output 620a that depicts bubble nucleation, growth, and collapse regions with sizes, opacities, and placement derived from pressure gradients and cavitation thresholds enforced by thermodynamic constraints.

A vibration telemetry input 605b contains frequency spectrum data from accelerometers or vibration sensors monitoring structural components. The vibration telemetry 605b undergoes spectral feature extraction (for example, via fast Fourier transforms) before being embedded into a latent manifold representation 610b that maintains frequency-domain structure and modal characteristics. A vibration projection operator R_vibration 615b transforms the latent vibration tensors into spatial displacement fields that represent structural deformation patterns. In an embodiment, mode shapes φ_i are recovered and a displacement field u(x)=Σ_i a_i φ_i(x) is constructed and mapped into visual coordinates; modal orthogonality constraints (for example, mass-normalized) and approximate energy consistency are enforced. The operator 615b produces a structural deformation visualization 620b showing displacement magnitudes and mode shapes, with deformed geometry overlaid on reference positions to illustrate dynamic response.

A flow telemetry input 605c comprises velocity field measurements from flow sensors distributed throughout a fluid system. The flow telemetry 605c is embedded into a latent manifold representation 610c that preserves fluid dynamic conservation laws and vorticity structures. A flow projection operator R_flow 615c maps the latent flow representation to visual coordinates that capture turbulent flow patterns and coherent structures. In an embodiment, local vorticity ω=∇×v and/or λ₂ criteria are computed from the latent tensors, and eddy glyph orientation, color, and scale are parameterized by |ω|, λ₂, and turbulence intensity metrics. The operator 615c generates a turbulence rendering output 620c that depicts vortex formations, eddy structures, and flow instabilities with visual elements that rotate and scale according to local dynamics while maintaining continuity and vorticity transport relationships.

Each projection operator 615a, 615b, and 615c implements a differentiable mathematical transformation from a sensor domain S_sensor⊂ [symbol] \hat{ }n to a visual manifold M_visual⊂ [symbol] \hat{ }m suitable for video rendering, where M_visual may include image-plane coordinates (u, v), depth, color/alpha, and time. The operators maintain domain-specific physical constraints, with R_pressure 615a enforcing thermodynamic consistency and cavitation thresholds, R_vibration 615b preserving modal orthogonality with energy-consistent scaling, and R_flow 615c maintaining continuity and vorticity transport. Projection operations are executed by processors as tensor functions that utilize exponential and logarithmic map operators for navigation between the curved latent manifold and the visual representation space while preserving differentiability for gradient-based optimization. Through these domain-specific transformations, projection operator library 135 enables video synthesis cortex 140 to generate physically meaningful visual representations from abstract latent manifold coordinates, maintaining interpretability and traceability between non-visual telemetry inputs 605a, 605b, 605c and corresponding visual outputs 620a, 620b, 620c.

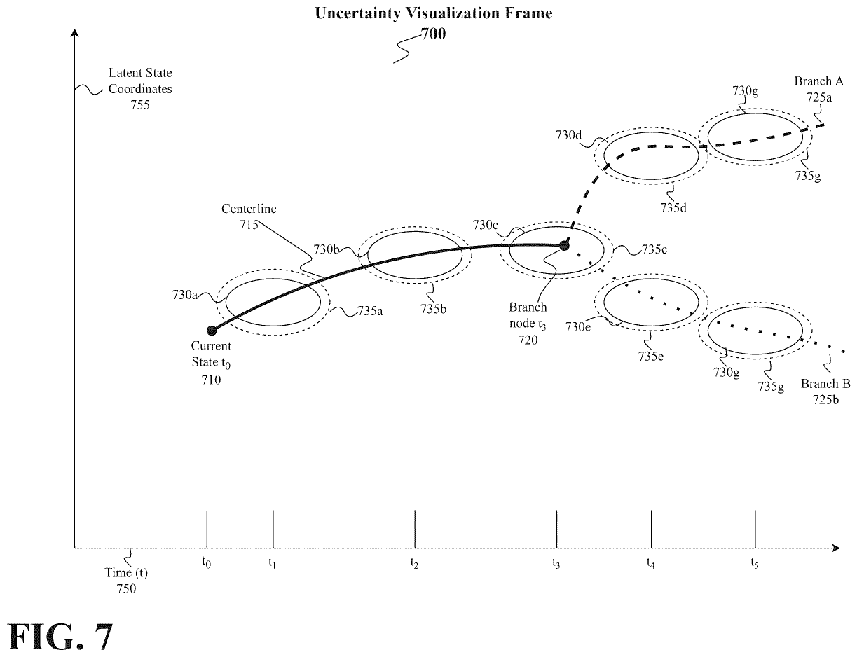

FIG. 7 is a technical diagram illustrating exemplary uncertainty encoding via covariance ellipses within a latent hyperspace-based predictive video rendering system 100, in an embodiment. An uncertainty visualization frame 700 defines a plotting area 705 bounded by a time axis 750 extending from t₀ to t₅ and a latent-state coordinate axis 755 representing a selected latent coordinate or a two-dimensional projection (for example, a principal component subspace) of a unified hyperspace representation produced by a latent hyperspace fusion engine 120. A current state point 710 at time t₀ represents an initial position of a monitored physical system within the latent manifold as determined from encoded telemetry processed by a tensor-preserving multimodal encoder 115. From current state point 710, a posterior mean centerline 715 extends through times t₁, t₂, and t₃, representing a most likely evolution path computed by a Bayesian fusion system 130 that combines geometric priors, stochastic rollouts, and historical kernel estimates produced by a predictive rollout engine 125.

At a branch node 720 occurring at time t₃, a multimodal posterior distribution bifurcates into two distinct prediction pathways. A branch A centerline 725A extends upward in latent space through times t₄ and t₅, and a branch B centerline 725B diverges downward through corresponding time periods, each representing an alternative system evolution regime identified by predictive rollout engine 125 and fused by Bayesian fusion system 130. Inner covariance ellipses 730a-n delineate equal-probability contours for a first confidence level (for example, approximately 68% for a bivariate normal using a χ² threshold), positioned at discrete time slices along posterior mean centerline 715 and branching centerlines 725A and 725B. Outer covariance ellipses 735a,b,c,d,e,f,g, . . . n surround corresponding inner ellipses 730a,b,c,d,e,f,g, . . . n and delineate a larger confidence level (for example, approximately 95%). Ellipse orientation and axis lengths are determined by the eigenvectors and eigenvalues of the posterior covariance Σ at each time slice, and ellipse dimensions generally increase with prediction horizon as implied by Σ. In the drawings, inner ellipses 730a-n are depicted with solid perimeters and outer ellipses 735a-n with dashed perimeters to indicate confidence levels.

A video synthesis cortex 140 may utilize covariance parameters encoded by ellipses 730a-n and 735a-n to modulate visual properties of generated predictive video, while a projection operator library 135 translates latent-space confidence bounds into domain-specific uncertainty encodings. Post-branching covariance ellipses along branch A centerline 725A and branch B centerline 725B may exhibit different growth rates and orientations reflecting distinct uncertainty characteristics of each pathway. A manifold journaling and audit system 145 records covariance parameters at each time slice together with branch node 720 decision points and associated probability weights, maintaining reversible mappings between the uncertainty visualizations and the underlying statistical distributions computed from telemetry inputs. All posterior statistics and covariance parameters described herein are computed by processor-executed tensor and probabilistic operations. This figure is a schematic visualization intended to illustrate relationships among computed mean trajectories, covariance contours, and branching; visual geometries are illustrative, not to scale, and do not indicate exact numerical values or proportions.

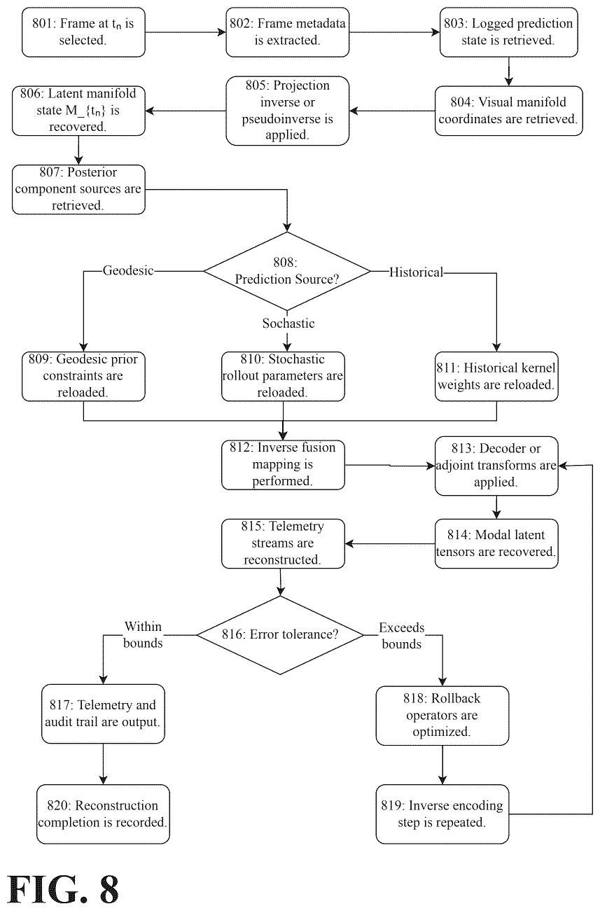

FIG. 8 is a flow diagram illustrating exemplary manifold journaling and reversibility in a latent hyperspace-based predictive video rendering system 100, in an embodiment. The process initiates when a predictive video frame at time tₙ generated by a video synthesis cortex 140 is selected for forensic reconstruction back to its originating telemetry sources 801. A manifold journaling and audit system 145 extracts frame metadata including temporal index tₙ, uncertainty parameters, transformation and operator identifiers, version tags, and any recorded random seeds from the selected video frame 802. The manifold journaling and audit system 145 queries persistent storage to retrieve the complete logged prediction state associated with tₙ, including operator parameters and cryptographic references 803. The system retrieves the visual manifold coordinates generated by a projection operator library 135 during the original forward prediction process 804.

An inverse, pseudoinverse, or adjoint projection mapping R\hat{ }{−1} from projection operator library 135 transforms the visual manifold coordinates back to latent hyperspace representations using the stored operator parameters; when no closed-form inverse exists, a numerically stable iterative solver with regularization is applied according to logged tolerances 805. The inverse mapping recovers a latent manifold state M_{tₙ} that corresponds to the predicted system configuration at time tₙ within recorded error bounds 806. A Bayesian fusion system 130 retrieves from the journal the constituent prediction components and parameters that were combined during forward processing to form the posterior at time tₙ 807. The retrieved components include identifiers and stored parameters for geodesic prior statistics, stochastic rollout bundles (transition operator versions, perturbation scales, and random seeds), and historical kernel weights with archival trajectory references 808.

Using these identifiers, the system reloads geodesic prior constraints computed from manifold curvature and reachability estimates by a predictive rollout engine 125 809. Concurrently, the system reloads stochastic rollout parameters including perturbation kernels and transition operators that were applied during short-horizon forecasting 810. The system also reloads historical kernel weights indicating which archived trajectories contributed to the prediction through similarity matching 811. A latent hyperspace fusion engine 120 applies an inverse or pseudoinverse fusion mapping—parameterized by multimodal landmarks and stored alignment parameters—to decompose the unified hyperspace state into its constituent modal submanifolds; where a direct inverse is unavailable, a constrained least-squares or variational optimization is executed 812.

A tensor-preserving multimodal encoder 115 applies decoder, inverse-encoding, or adjoint transformations to map latent tensor representations back toward their sensor-specific formats using stored normalization and checkpoint parameters 813. The inverse encoding process recovers modal-specific latent tensors corresponding to individual sensor modalities such as vibration, flow, pressure, thermal, chemical, and electromagnetic measurements 814. The system reconstructs the original telemetry streams by applying calibration parameters, sampling rates, synchronization offsets, and sensor metadata stored by a multimodal telemetry ingestion layer 105, including resampling to native time bases 815. A verification process computes reconstruction error between reconstructed telemetry and journaled references using objective metrics such as channel-wise L₂ or L∞ norms, spectral discrepancy (e.g., power spectral density error), dynamic time-warping distance, and correlation coefficients, and validates journal integrity via cryptographic hash-chain and/or digital signature verification; acceptance requires errors within recorded tolerances and successful integrity verification 816.

When reconstruction error is within acceptable bounds and integrity checks pass, the system outputs the source telemetry data along with a complete audit trail documenting all intermediate transformations, operator versions, parameters, and verification artifacts 817. When reconstruction error exceeds tolerance thresholds or integrity verification fails, an optimization process refines rollback operators through iterative adjustment of inverse/pseudoinverse parameters (e.g., regularization weights, solver tolerances, stopping criteria) and/or selection of alternative adjoint strategies 818. After refinement, the process returns to the inverse encoding step to attempt improved reconstruction with updated operators 819. Upon successful verification, the manifold journaling and audit system 145 completes the reversible reconstruction, having traced the predictive video frame through all computational layers back to its originating sensor measurements with documented, tamper-evident lineage 820.

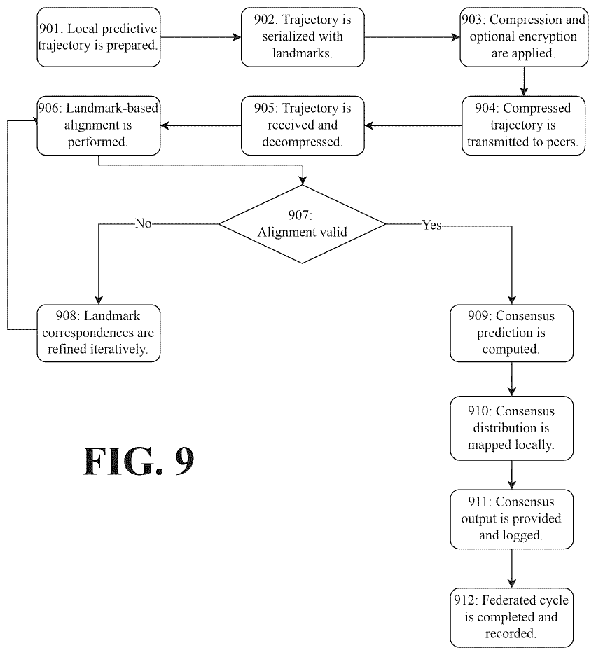

FIG. 9 is a flow diagram illustrating exemplary federated prediction operations in a latent hyperspace-based predictive video rendering system 100, in an embodiment. The process initiates when a local persistent cognitive machine instance generates a predictive trajectory through a predictive rollout engine 125 and determines to share the prediction with distributed network nodes 901. A federated prediction interface 150 serializes the local predictive trajectory with multimodal landmark anchors and operator/version identifiers that serve as shared geometric reference points across distributed cognitive substrate instances 902. The federated prediction interface 150 applies structure-preserving compression (for example, manifold-aware vector quantization or sparse control-point encoding) and, in some embodiments, homomorphic encryption that enables permitted aggregation on ciphertexts, thereby reducing bandwidth while preserving geometric structure and computational privacy 903. The compressed predictive trajectory is transmitted through network interfaces to other persistent cognitive machine instances participating in the federated prediction network 904.

Remote persistent cognitive machine instances receive the compressed trajectory data through their respective federated prediction interfaces 150 and perform decompression operations that restore geometric structure; when encrypted, permitted federated computations are performed homomorphically prior to decryption at authorized nodes 905. A geometric alignment process utilizes the embedded multimodal landmarks to register the received trajectory to each remote instance's local latent manifold representation maintained by its latent hyperspace fusion engine 120 (for example, Procrustes/ICP or Riemannian Procrustes with isometric or affine constraints) 906. Alignment quality is evaluated using landmark root-mean-square residuals and geodesic-distortion metrics against a threshold &_align to determine suitability for prediction fusion 907. When alignment quality falls below threshold criteria, a refinement process adjusts landmark correspondences through iterative optimization of geometric transformation parameters (for example, Levenberg-Marquardt on rotation/scale/translation or local parallel-transport fields) 908.

Upon achieving valid alignment, a consensus prediction protocol aggregates the aligned trajectories from multiple persistent cognitive machine instances, weighting each contribution according to confidence scores derived from their respective Bayesian fusion systems 130; in an embodiment, a Riemannian barycenter (Karcher mean) or a product-of-experts posterior is computed in manifold coordinates 909. The consensus prediction is transported into each participating instance's local manifold space via landmark-based maps or parallel transport and then expressed in the local coordinate system using projection operator library 135 910. The federated prediction interface 150 outputs the consensus-refined prediction for use by the local video synthesis cortex 140 in generating uncertainty-aware predictive video; all serialization, compression/encryption, alignment, consensus, and transport computations are executed by processors and the exchange is logged with cryptographic signatures and timestamps 911. The federated prediction cycle completes with the local instance enhancing its predictive capabilities through collaborative computation while maintaining sovereignty over local manifold parameters and processes, and manifold journaling and audit system 145 records received trajectory identifiers, alignment parameters, consensus weights, and verification artifacts for auditability 912.

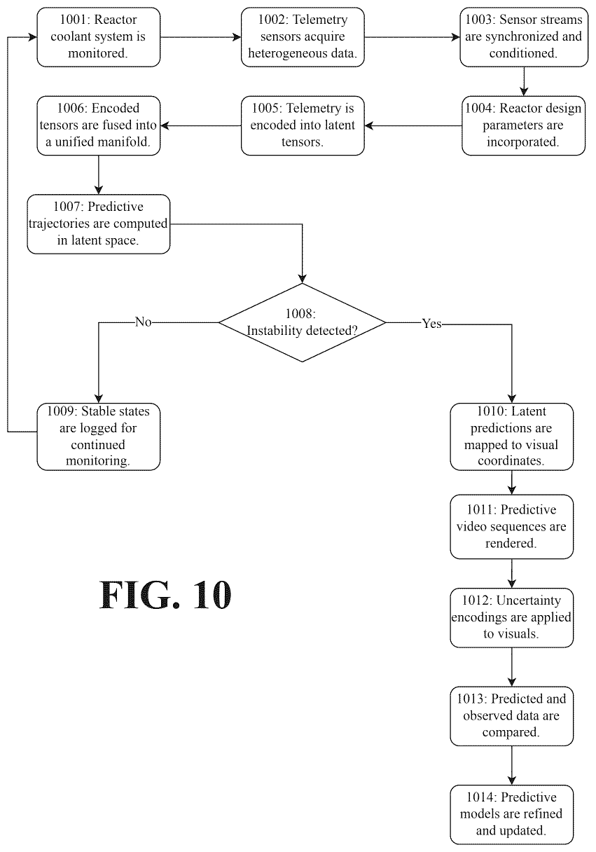

FIG. 10 is a flow diagram illustrating exemplary nuclear reactor coolant monitoring implementation in a latent hyperspace-based predictive video rendering system 100, in an embodiment. The process initiates with a nuclear reactor coolant system comprising pumps, piping structures, and reactor vessel internals that require continuous monitoring for operational safety 1001. A deployment of telemetry sensors including vibration sensors on pump housings, pressure transducers in coolant lines, flow meters at critical junctions, distributed acoustic sensors along piping, and thermal sensors throughout the coolant loop provides heterogeneous non-visual measurements of system dynamics 1002. A multimodal telemetry ingestion layer 105 receives the sensor streams and performs temporal synchronization, signal conditioning, and metadata association to prepare the data for encoding 1003. A contextual knowledge integration system 110 incorporates reactor-specific design parameters including hydraulic geometry, thermal limits, operational pressure boundaries, and historical coolant instability patterns to constrain subsequent predictive operations 1004.

A tensor-preserving multimodal encoder 115 transforms each telemetry stream into latent tensor representations, with vibration data encoded as spectral tensors, flow and pressure data as fluid dynamic state vectors preserving conservation relationships, and thermal data as heat transfer tensors maintaining thermodynamic balance 1005. A latent hyperspace fusion engine 120 combines the encoded tensor representations into a unified manifold state using geometric operations guided by connection coefficients, establishing correlations between thermal, mechanical, and hydraulic variables 1006. A predictive rollout engine 125 computes forward trajectories through the latent manifold using geodesic forecasting constrained by thermodynamic conservation laws and stochastic perturbations representing coolant density variations and pump vibration uncertainties 1007. The system evaluates whether the predicted trajectories indicate approaching instability conditions such as cavitation onset, flow-induced vibration amplification, or thermal stratification 1008.

When predicted trajectories remain within stable operational bounds, the system continues routine monitoring with updated state information feeding back to the telemetry ingestion layer 105 1009. When instability indicators exceed threshold criteria, a projection operator library 135 applies domain-specific transformations to map the latent predictions into visual manifold coordinates representing coolant flow patterns, pressure distributions, and cavitation regions 1010. A video synthesis cortex 140 generates predictive instability video sequences showing anticipated evolution of turbulence patterns, cavitation bubble formation, or pump vibration amplification several seconds before such conditions would physically manifest 1011. The system alerts reactor operators through the generated video output with uncertainty encoding that renders high-confidence predictions at full opacity while regions of greater uncertainty appear with graduated transparency, enabling operators to assess both the predicted instability and associated confidence levels 1012.

A validation process compares the predicted system evolution against subsequently observed telemetry data from the sensor array to assess prediction accuracy 1013. Based on validation results, the system updates predictive models within the predictive rollout engine 125 by adjusting manifold curvature penalties and refining transition operators to improve future forecasting performance for the reactor coolant system 1014.

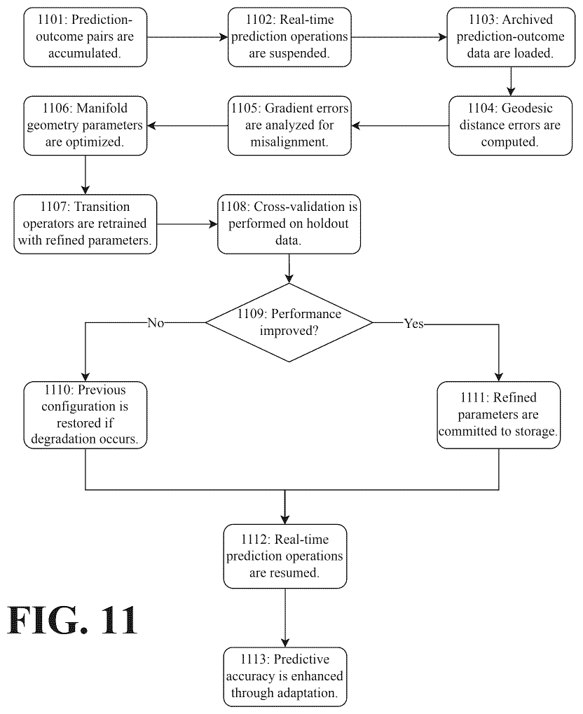

FIG. 11 is a flow diagram illustrating exemplary sleep-state consolidation in a latent hyperspace-based predictive video rendering system 100, in an embodiment. The process initiates when a persistent cognitive substrate determines that sufficient prediction-outcome pairs have accumulated to warrant parameter optimization through offline consolidation 1101. The system suspends real-time prediction operations within a predictive rollout engine 125 to allocate computational resources for intensive optimization processes 1102. A manifold journaling and audit system 145 loads archived prediction-outcome data comprising predicted trajectories and their corresponding observed telemetry measurements collected since the previous consolidation cycle 1103. The system computes geodesic distance errors between predicted latent manifold positions and actual positions derived from observed telemetry, quantifying prediction accuracy in the geometric framework maintained by a latent hyperspace fusion engine 120 1104.

An optimization process calculates gradients of prediction error with respect to manifold curvature parameters, identifying regions where geometric constraints may be misaligned with observed system dynamics 1105. The system optimizes manifold geometry parameters including connection coefficients, curvature penalties, and compression-pressure field configurations to minimize prediction errors across the archived dataset 1106. A predictive rollout engine 125 retrains its transition operators T: M_t→M_{t+Δt} using the refined geometric parameters, adjusting how latent states evolve through the manifold based on observed prediction discrepancies 1107. The system performs cross-validation on holdout trajectory sets that were excluded from the optimization process to assess whether the refined parameters generalize to unseen data 1108.

A performance evaluation determines whether the refined parameters yield improved prediction accuracy compared to the previous configuration 1109. When performance metrics indicate degradation or insufficient improvement, the system restores the previous parameter configuration from a stored checkpoint to maintain predictive stability 1110. When performance metrics confirm improvement, the system commits the refined parameters to persistent storage within a contextual knowledge integration system 110 for use in subsequent prediction cycles 1111. The system resumes real-time prediction operations with the updated manifold geometry and transition operators integrated into the active predictive pipeline 1112. The sleep-state consolidation cycle completes with the persistent cognitive substrate having adapted its internal representations based on empirical prediction performance, enhancing future forecasting accuracy for the monitored physical system 1113.

### Exemplary Computing Environment

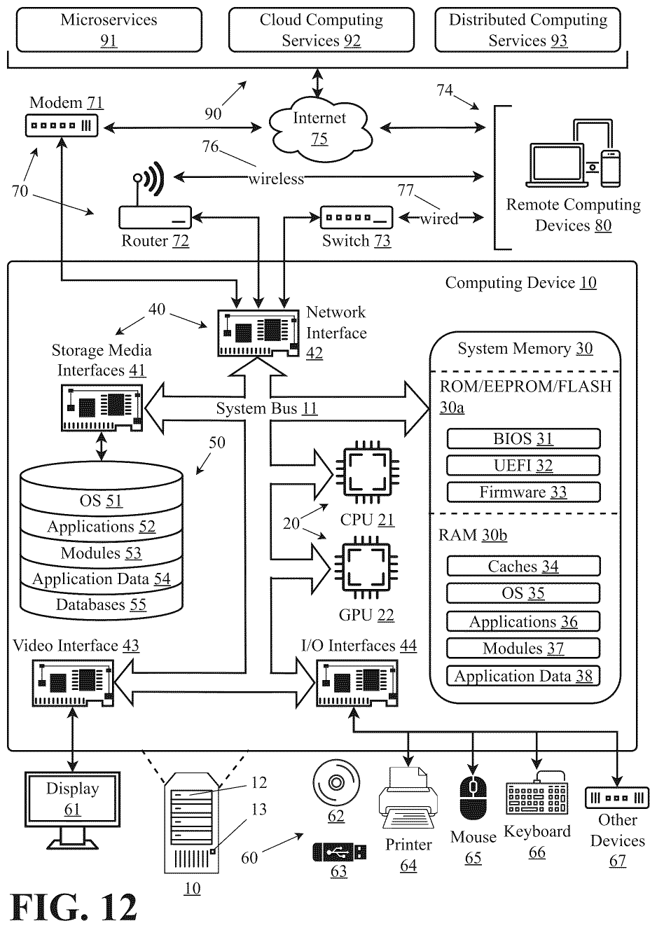

FIG. 12 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 13 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Containerd provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A computer system for generating visual representations of physical system states from non-visual sensor data, the system comprising a hardware memory, wherein the computer system is configured to execute software instructions stored on nontransitory machine-readable storage media that:
maintain a persistent cognitive substrate incorporating a latent manifold with geometric representations of physical system states;
receive telemetry data from a plurality of non-visual sensing modalities monitoring a physical system, wherein the telemetry data comprises at least one of vibration, acoustic, flow, pressure, thermal, chemical, or electromagnetic sensor measurements;
encode the telemetry data into tensor-preserving latent representations within the latent manifold while maintaining geometric structure relationships and temporal correlations;
compute predictive trajectories through the latent manifold by applying at least one of geodesic forecasting operators, stochastic perturbation kernels, or historical trajectory matching, wherein the predictive trajectories represent anticipated evolution of the physical system state;
apply projection operators that transform the predictive trajectories into visual manifold coordinates according to domain-specific physical constraints and uncertainty bounds;
generate synthetic video output representing predicted future states of the physical system by decoding the visual manifold coordinates, wherein the synthetic video provides visual representation of anticipated system evolution derived from the non-visual telemetry data;
incorporate uncertainty quantification into the synthetic video through at least one of opacity gradients, branching trajectory overlays, or probabilistic confidence encodings; and
maintain reversible mappings between the generated synthetic video and the source telemetry data through manifold journaling with bounded error tolerances.

2. The computer system of claim 1, wherein the system further incorporates contextual information about the physical system comprising structural design parameters, operational tolerances, and historical performance data to constrain the predictive trajectories to physically plausible future states.

3. The computer system of claim 1, wherein the system implements a Bayesian fusion system that combines geodesic priors derived from manifold geometry with short-horizon latent rollouts and historical trajectory archives to generate posterior distributions over predicted system states.

4. The computer system of claim 1, wherein the projection operators comprise domain-specific mappings that transform vibration telemetry into structural deformation visualizations, flow telemetry into fluid dynamics representations, and pressure telemetry into stress distribution renderings.

5. The computer system of claim 1, wherein the uncertainty quantification dynamically adjusts visual opacity in proportion to prediction confidence, rendering highly certain predictions with full opacity and uncertain regions with graduated transparency.

6. The computer system of claim 1, wherein the system generates branching trajectory visualizations that diverge at critical decision points to illustrate multiple plausible system evolution paths when the posterior distribution exhibits multimodal characteristics.

7. The computer system of claim 1, wherein the manifold journaling maintains cryptographic verification of the complete prediction lineage, enabling forensic reconstruction of any predictive video frame back to its originating telemetry inputs and intermediate computational states.

8. The computer system of claim 1, wherein the system implements federated prediction capabilities enabling multiple distributed cognitive substrate instances to share predictive trajectories anchored by common multimodal landmarks while maintaining local computational sovereignty.

9. The computer system of claim 1, wherein the synthetic video output highlights regions of predicted anomalies, instabilities, or failure modes through visual emphasis techniques comprising color gradients, pulsation effects, or trajectory highlighting before such conditions manifest in the physical system.

10. The computer system of claim 1, wherein the system implements a sleep-state consolidation process that periodically optimizes the predictive trajectory operators by analyzing prediction accuracy against subsequently observed telemetry data and adjusting manifold curvature penalties accordingly.

11. A computer-implemented method for generating visual representations of physical system states from non-visual sensor data, the method comprising:
maintaining a persistent cognitive substrate incorporating a latent manifold with geometric representations of physical system states;
receiving telemetry data from a plurality of non-visual sensing modalities monitoring a physical system, wherein the telemetry data comprises at least one of vibration, acoustic, flow, pressure, thermal, chemical, or electromagnetic sensor measurements;
encoding the telemetry data into tensor-preserving latent representations within the latent manifold while maintaining geometric structure relationships and temporal correlations;
computing predictive trajectories through the latent manifold by applying at least one of geodesic forecasting operators, stochastic perturbation kernels, or historical trajectory matching, wherein the predictive trajectories represent anticipated evolution of the physical system state;
applying projection operators that transform the predictive trajectories into visual manifold coordinates according to domain-specific physical constraints and uncertainty bounds;
generating synthetic video output representing predicted future states of the physical system by decoding the visual manifold coordinates, wherein the synthetic video provides visual representation of anticipated system evolution derived from the non-visual telemetry data;
incorporating uncertainty quantification into the synthetic video through at least one of opacity gradients, branching trajectory overlays, or probabilistic confidence encodings; and
maintaining reversible mappings between the generated synthetic video and the source telemetry data through manifold journaling with bounded error tolerances.

12. The method of claim 11, further comprising incorporating contextual information about the physical system comprising structural design parameters, operational tolerances, and historical performance data to constrain the predictive trajectories to physically plausible future states.

13. The method of claim 11, further comprising implementing a Bayesian fusion process that combines geodesic priors derived from manifold geometry with short-horizon latent rollouts and historical trajectory archives to generate posterior distributions over predicted system states.

14. The method of claim 11, wherein applying projection operators comprises implementing domain-specific mappings that transform vibration telemetry into structural deformation visualizations, flow telemetry into fluid dynamics representations, and pressure telemetry into stress distribution renderings.

15. The method of claim 11, wherein incorporating uncertainty quantification comprises dynamically adjusting visual opacity in proportion to prediction confidence, rendering highly certain predictions with full opacity and uncertain regions with graduated transparency.

16. The method of claim 11, further comprising generating branching trajectory visualizations that diverge at critical decision points to illustrate multiple plausible system evolution paths when the posterior distribution exhibits multimodal characteristics.

17. The method of claim 11, wherein maintaining reversible mappings comprises maintaining cryptographic verification of the complete prediction lineage, enabling forensic reconstruction of any predictive video frame back to its originating telemetry inputs and intermediate computational states.

18. The method of claim 11, further comprising implementing federated prediction operations enabling multiple distributed cognitive substrate instances to share predictive trajectories anchored by common multimodal landmarks while maintaining local computational sovereignty.

19. The method of claim 11, wherein generating synthetic video output comprises highlighting regions of predicted anomalies, instabilities, or failure modes through visual emphasis techniques comprising color gradients, pulsation effects, or trajectory highlighting before such conditions manifest in the physical system.

20. The method of claim 11, further comprising implementing a sleep-state consolidation process that periodically optimizes the predictive trajectory operators by analyzing prediction accuracy against subsequently observed telemetry data and adjusting manifold curvature penalties accordingly.
